(19) United States
(12) Patent Application Publication
(10) Pub. No.: US 2021/0122917 A1
(43) Pub. Date: Apr. 29, 2021

(54) COLOR MIGRATION BLOCKING COMPOSITION, COLOR MIGRATION BLOCKING FILM, COLOR MIGRATION BLOCKING LAMINATE AND COMPOSITE FABRIC COMPRISING THE SAME, AND APPLICATIONS THEREOF

(71) Applicants: Yuh-Jye UANG, Taichung City (TW); CHI-SHIH LEE, Taichung City (TW)

(72) Inventor: Yuh-Jye UANG, Taichung City (TW)

(21) Appl. No.: 17/072,151

(22) Filed: Oct. 16, 2020

(30) Foreign Application Priority Data
Oct. 24, 2019 (TW) 108138387

(51) Int. Cl. C08L 71/10; B32B 27/40; B32B 27/08; B32B 27/38; B32B 27/30; B32B 27/26; B32B 7/12; C09J 7/35; C09J 7/29; C08G 59/14; C08G 59/40; C08G 59/50

(52) U.S. Cl. CPC C08L 71/10; C09J 2301/414; B32B 27/08; B32B 27/38; B32B 27/308; B32B 27/26; B32B 7/12; C09J 7/35; C09J 7/29; C08G 59/14; C08G 59/4028; C08G 59/50; B32B 2375/00; B32B 2363/00; B32B 2355/00; B32B 2307/738; B32B 2307/4026; B32B 27/40

(57) ABSTRACT

The present invention provides a color migration blocking composition, comprising: 15 parts to 45 parts by weight of a phenoxy resin; 5 parts to 40 parts by weight of an elastomer-modified epoxy resin; 1.5 parts to 7.0 parts by weight of a curing agent; and 30 parts to 65 parts by weight of a solvent, based on the total weight of the color migration blocking composition. The color migration blocking film formed by the color migration blocking composition has a good effect on blocking color migration and a good adhesion strength; therefore, when a color migration blocking laminate comprising the color migration blocking film is applied to a fabric, not only the unnecessary discoloration can be avoided and the softness of the fabric can be maintained, but also the processing cost is reduced, thereby promoting the value of the product.

### BACKGROUND OF THE INVENTION

### 1. Field of the Invention

The present invention relates to a color migration blocking composition, a color migration blocking film formed by the color migration blocking composition and a laminate comprising the color migration blocking film, and particularly relates to the color migration blocking composition, the color migration blocking film and laminate applied to a synthetic leather composite fabric.

### 2. Description of the Prior Arts

Synthetic leather composite fabrics usually comprise a variety of products formed by adhering a synthetic leather to a fabric as the base substrate. Since the synthetic leather composite fabrics have advantages of easy production, lightweight, and abundance in material and pattern, they can be widely applied to clothes, shoe materials, hats, cloth labels, backpacks, furniture and other products. And, with the technological development in the plastic industry, these synthetic leather composite fabrics have become one of the most important materials used in the daily necessities industry.

Generally, the main material of the synthetic leather can be polyvinyl chloride (PVC), polyurethane (PU) and the like; and polyurethane has become the most common synthetic leather material because the polyurethane film is similar to the genuine leather in both haptic sensation and appearance, has great vapor permeability and great water resistance, and can be embossed with varied patterns.

To reduce the labor cost and obtain the composite fabrics with a variety of designs in different patterns and colors, the no-sew heat pressing method is often applied in the recent days, to give a synthetic leather comprising a laminate and dyed fabric. The laminate comprises a polyurethane film, a high temperature thermoplastic polyurethane film, and a low temperature thermoplastic polyurethane hot melt film; wherein the laminate is adhered to a color fabric by the low temperature thermoplastic polyurethane hot melt film (as a hot melt adhesive). However, during the heat pressing process, the dye colorant in the fabric will migrate from the fabric to the surface of polyurethane film, the top layer of the synthetic leather, then the color migration will affect the original color of polyurethane film, and even the appearance of the fabric will be damaged.

With reference to U.S. Pat. No. 8,859,461 B2, Eiji Kuwahara discloses a decoration piece comprising a dye migration preventing layer, and the dye migration preventing layer is made of ethylene-vinyl alcohol copolymer (EVOH), or polyamide MXD6, or polyvinylidene chloride (PVDC).

However, EVOH absorbs water easily, and the thermoplastic polyurethane film comprised in the laminate can be hydrolyzed because of the high water absorbency of the dye migration preventing layer. In addition, EVOH comprises a large amount of nonpolar polyethylene, which reduces the adhesion strength between the dye migration preventing layer (made of EVOH) and any other layer. Another dye migration preventing layer is made of polyamide MXD6, this polyamide layer cannot be adhered to the thermoplastic urethane layer easily due to its high melting point. To increase the adhesion strength between the polyamide MXD6 layer and the thermoplastic urethane layers, two layers of adhesive are needed according to the existing technology, in which the adhesive and the dye migration preventing material are co-extruded to make the dye migration preventing layer inserted between two adhesive layers. Nevertheless, this production method not only reduces the softness of the laminate, but also increases the production cost of the laminate. When the dye migration preventing layer is made of polyvinylidene chloride, it is not suitable for a heat pressing method because polyvinylidene chloride has poor thermal stability. Moreover, polyvinylidene chloride comprises chlorine atoms, which may be hazardous to our health and the environment.

To overcome the shortcomings, the present invention provides a color migration blocking composition, a color migration blocking film formed by the color migration blocking composition, a color migration blocking laminate comprising the color migration blocking film, and a composite fabric comprising the color migration blocking laminate to mitigate or obviate the aforementioned problems.

### SUMMARY OF THE INVENTION

The first objective of the present invention is to provide a color migration blocking composition and a color migration blocking film made of the color migration blocking composition, in which the color migration blocking film not only has a good effect on blocking color migration from dyed fabrics, but also has good vamp flexing and/or a good adhesion strength.

Another objective of the present invention is to provide a color migration blocking film composition and a color migration blocking film made of the color migration blocking composition, in which the color migration blocking film has a good hydrolysis resistant ability.

To achieve the foregoing objectives, the present invention provides a color migration blocking composition, comprising: 15 percent by weight (wt %) to 45 wt % of a phenoxy resin; 5 wt % to 40 wt % of an elastomer-modified epoxy resin; 1.5 wt % to 7.0 wt % of a curing agent; and 30 wt % to 65 wt % of a solvent, based on the total weight of the color migration blocking composition.

According to the present invention, the color migration blocking composition comprises a phenoxy resin and an elastomer-modified epoxy resin which are compatible with polyurethane, so the color migration blocking film made of the color migration blocking composition has a good adhesion strength with a polyurethane film. In addition, both the phenoxy resin and the elastomer-modified epoxy resin have a good blocking ability to polar and nonpolar gases, so the composition can successfully block the migration of the sublimated dye caused by the heat during the heat pressing process from the dyed fabric at the bottom to the polyurethane film at the top.

According to the present invention, the phenoxy resin can be polyhydroxyether having terminal alpha-glycol groups. The phenoxy resin is a tough and ductile linear thermoplastic material having high cohesive strength and good impact resistance. In the phenoxy resin, the backbone ether linkage and pendant hydroxyl groups promote wetting and bonding to polar substrate such as polyurethane and fillers. In addition, the phenoxy resin has excellent vapor barrier properties (to water vapor, oxygen, carbon dioxide). In the present invention, the weight average molecular weight (Mw) of the phenoxy resin is not specifically limited. Preferably, the phenoxy resin has a weight average molecular weight of 20,000 to 80,000; more preferably, the phenoxy resin has a weight average molecular weight of 32,000 to 65,000. For example, the phenoxy resin may be jER™ 1256, 4250, 4275 purchased from Mitsubishi Chemical, Japan. In some embodiments, the color migration blocking composition comprises two or more phenoxy resins having different molecular weights, and the resulting film has advantages of high toughness and good ductility.

According to the present invention, the elastomer-modified epoxy resin is obtained by the reactions between the epoxide group from an epoxy resin and the reactive terminal functional group from a modifying additive such as dimer acid, thermoplastic polyurethane (TPU), or liquid rubber, and the reaction products are respectively a dimer acid-modified epoxy resin, a thermoplastic polyurethane-modified epoxy resin (TPU-modified epoxy resin), and a rubber modified epoxy resin. These elastomer-modified epoxy resins provide flexible chain segments which adjust the hardness and stiffness of the epoxy resin, and improve the elastomer-modified epoxy resins to have better toughness, ductility, impact resistance and/or good adhesion and peel strength. For example, the epoxy resin can be bisphenol A diglycidyl ether (DGEBA), neopentylglycol diglycidyl ether (DGENPG), but not limited thereto. The dimer acid is a fatty acid dimer, such as oleic acid dimer, but not limited thereto; the TPU may be an amino-terminated thermoplastic polyurethane (amino-terminated TPU), but not limited thereto; the liquid rubber may be polysulfide rubber, such as a hydroxyl-terminated butadiene-acrylonitrile liquid rubber, a carboxyl-terminated butadiene-acrylonitrile liquid rubber, but not limited thereto. Preferably, the elastomer-modified epoxy resin comprises: a dimer acid-modified epoxy resin, a TPU-modified epoxy resin, a butadiene-acrylonitrile liquid rubber-modified epoxy resin or a combination thereof.

Preferably, the elastomer is in an amount of 5 wt % to 50 wt % based on the total weight of the elastomer-modified epoxy resin.

Regarding the dimer acid-modified epoxy resin, the introduction of the fatty acid to the backbone (such as DGEBA) yields a resin which will impart a degree of flexibility and toughness, the crosslink density of the epoxy resin is reduced after curing, and the resulting film has higher toughness, impact resistance, water resistance and adherence. Specifically, the dimer acid-modified epoxy resin can be obtained from the addition reaction between DGEBA and a fatty acid dimer. DGEBA and the fatty acid dimer can be reacted at different weight ratios, respectively. Preferably, DGEBA is in an amount of 50 wt % to 80 wt %, and the fatty acid dimer is in an amount of 20 wt % to 50 wt %, based on the total weight of the dimer acid-modified epoxy resin. Preferably, the dimer acid-modified epoxy resin has an epoxide equivalent weight (EEW) of 500 grams per equivalent (g/eq) to 1500 g/eq. For example, the dimer acid-modified epoxy resin may be HyPox DA323 purchased from CVC Thermoset Specialties.

Regarding the TPU-modified epoxy resin, the TPU-modified epoxy resin can be obtained from the heating reaction between DGEBA with the amino-terminated TPU at different weight ratios, respectively. Preferably, based on the total weight of the TPU-modified epoxy resin, the DGEBA is in an amount of 50 wt % to 90 wt % while the amino-terminated TPU is in an amount of 10 wt % to 50 wt %. Preferably, the TPU-modified epoxy resin has an epoxide equivalent weight of 200 g/eq to 700 g/eq. For example, the TPU-modified epoxy resin may be HyPox UA10 purchased from CVC Thermoset Specialties.

Regarding the butadiene-acrylonitrile liquid rubber-modified epoxy resin, the butadiene-acrylonitrile liquid rubber is introduced into the epoxy resin, after curing the epoxy resin, the rubber microparticles with a microphase separation structure are formed, which promotes the stress absorption capability of the resulting film, thereby increasing the toughness, impact resistance, ductility, thermal shock resistance, shear strength at low temperature and peel strength of the film. Specifically, the butadiene-acrylonitrile liquid rubber-modified epoxy resin can be obtained from the addition reaction between DGEBA and a carboxyl-terminated butadiene-acrylonitrile liquid rubber (CTBN). DGEBA and CTBN can be reacted at different weight ratios, respectively. Preferably, DGEBA is in an amount of 50 wt % to 95 wt %, and CTBN is in an amount of 5 wt % to 50 wt %, based on the total weight of the butadiene-acrylonitrile liquid rubber-modified epoxy resin. Preferably, the butadiene-acrylonitrile liquid rubber-modified epoxy resin has an epoxide equivalent weight of 300 g/eq to 1400 g/eq. For example, the butadiene-acrylonitrile liquid rubber-modified epoxy resin may be HyPox RA 1340 purchased from CVC Thermoset Specialties.

In some embodiments, the color migration blocking composition may simultaneously comprise different elastomer-modified epoxy resins. Preferably, the elastomer-modified epoxy resin comprises a TPU-modified epoxy resin.

According to the present invention, the curing agent comprises an isocyanate type curing agent, an amine type curing agent or a combination thereof. In some embodiments, the color migration blocking composition may simultaneously comprise different curing agents, such as a combination of two different isocyanate type curing agents, a combination of two different amine type curing agents, or a combination comprising an isocyanate type curing agent and an amine type curing agent, but not limited thereto.

Specifically, the isocyanate type curing agent may be a polyisocyanate, the composition thereof, or the oligomer thereof, and the polyisocyanate comprises a diisocyanate or a triisocyanate, but not limited thereto. The isocyanate type curing agent may be an aliphatic polyisocyanate, an aromatic polyisocyanate or a heterocyclic isocyanate. For example, the aliphatic polyisocyanate may be 1,6-hexamethylene diisocyanate (HDI), 2,2,4-trimethylhexamethylene diisocyanate (2,2,4-TMDI), cyclohex-1,4-ylene diisocyanate, or 5-isocyanato-1-(isocyanatomethyl)-1,3,3-trimethylcyclohexane (IPDI), but not limited thereto; the aromatic polyisocyanate may be 2,4-toluene diisocyanate (2,4-TDI), or 4,4′-diphenylmethane diisocyanate (4,4′-MDI), but not limited thereto.

Specifically, the amine type curing agent may be an aliphatic polyamine, an aromatic polyamine, or a low molecular weight polyamide, but not limited thereto.

According to the present invention, the solvent is not specifically limited. Preferably, the solvent comprises a first solvent and a second solvent; the first solvent is a polar aprotic solvent, and the second solvent is a hydrocarbon solvent. For example, the first solvent may be cyclohexanone, methyl ethyl ketone (MEK), 1-methoxy-2-propyl acetate (PMA), 1-methoxy-2-propanol (PM), or dipropylene glycol methyl ether (DPM), but not limited thereto. Preferably, the first solvent comprises MEK or PMA. The second solvent may comprise an aliphatic hydrocarbon (e.g., pentane, hexane), or an aromatic hydrocarbon (e.g., xylene), but not limited thereto. For example, the second solvent can be the aromatic hydrocarbon with the product name Aromatic 100.

Preferably, the color migration blocking composition comprises 20 wt % to 42 wt % of a phenoxy resin, 5 wt % to 25 wt % of an elastomer-modified epoxy resin, 2.0 wt % to 7.0 wt % of a curing agent, and 40 wt % to 58 wt % of a solvent, based on the total weight of the color migration blocking composition. As long as the effect of the present invention is not affected, an appropriate amount of an auxiliary can be added into the color migration blocking composition based on practical needs, such as a defoaming agent, a wetting agent, or a leveling agent, but not limited thereto. Specifically, the addition of the defoaming agent can reduce the bubbles during the coating of the color migration blocking composition on a release carrier; in addition, the wetting agent or the leveling agent can reduce the surface tension of the release carrier, and avoid the uneven thickness of the dried coated film.

The present invention also provides a color migration blocking film, which has a good effect on blocking color migration and has good adhesion strength with any other layer (such as with the first polyurethane film and the thermoplastic polyurethane film, or with the thermoplastic polyurethane film and thermoplastic polyurethane hot melt film). The color migration blocking film is formed by using the above-mentioned color migration blocking composition. For example, the color migration blocking film can be formed by coating and drying the color migration blocking composition on a releasing film, or by extruding and casting with an extrusion casting equipment, but not limited thereto.

Preferably, the thickness of the color migration blocking film ranges from 0.02 millimeter (mm) to 1.0 mm. More preferably, the thickness of the color migration blocking film ranges from 0.03 mm to 0.08 mm.

Yet another objective of the present invention is to provide a color migration blocking laminate, comprising: a first polyurethane film, the color migration blocking film, a thermoplastic polyurethane film (TPU film), and a thermoplastic polyurethane hot melt film (TPU hot melt film); wherein the color migration blocking film and the TPU film are inserted between the first polyurethane film and the TPU hot melt film.

In the first embodiment, the color migration blocking laminate comprises sequentially from top to bottom: the first polyurethane film, the color migration blocking film, the TPU film, and the TPU hot melt film.

In the second embodiment, the color migration blocking laminate comprises sequentially from top to bottom: the first polyurethane film, the TPU film, the color migration blocking film, and the TPU hot melt film.

Since the color migration blocking film is very compatible with the TPU film and TPU hot melt film, no additional adhesive layer is needed to be applied to the opposed two sides of the color migration blocking film. The color migration blocking film has good adhesion strength to the first polyurethane film, TPU film and TPU hot melt film.

To obtain better adhesion strength between the first polyurethane film and any other layer in the laminate, the color migration blocking laminate preferably further comprises a polyurethane adhesive layer which is inserted between the first polyurethane film and the color migration blocking film. Alternatively, the polyurethane adhesive layer is inserted between the first polyurethane film and the TPU film.

In the third embodiment (i.e., the polyurethane adhesive layer is added in the first embodiment), the color migration blocking laminate comprises sequentially from top to bottom: the first polyurethane film, the polyurethane adhesive layer, the color migration blocking film, the TPU film, and the TPU hot melt film.

In the fourth embodiment (i.e., the polyurethane adhesive layer is added in the second embodiment), the color migration blocking laminate comprises sequentially from top to bottom: the first polyurethane film, the polyurethane adhesive layer, the TPU film, the color migration blocking film, and the TPU hot melt film.

Preferably, the thickness of the color migration blocking laminate ranges from 0.21 mm to 1.80 mm. More preferably, the thickness of the color migration blocking laminate ranges from 0.23 mm to 1.60 mm.

According to the present invention, the first polyurethane film can be used as the top layer of a synthetic leather. This first polyurethane film can be subjected to a coloring process to show a variety of color, or an embossing process to have designated patterns, or a metal film lamination process to show metallic luster, or a printing process to show the logo design, but not limited thereto. Preferably, the first polyurethane film has a thickness of 0.03 mm to 0.06 mm, but not limited thereto. Specifically, the first polyurethane film can be obtained through dry-coating either with a water-based polyurethane solution or with a solvent-based polyurethane solution, but not limited thereto. In some embodiments, the first polyurethane film is subjected to a coloring process treatment, by using an organic or an inorganic colorant comprising titanium dioxide and carbon black, but not limited thereto.

According to the present invention, the TPU film can increase the durability of the overall color migration blocking laminate. Preferably, the TPU film has a thickness of 0.08 mm to 1.0 mm, but not limited thereto. Specifically, the TPU film can be obtained through T-die extrusion equipment with TPU pellets, but not limited thereto. The melting point of the TPU film needs to be higher than the melting point of the TPU hot melt film. Specifically, the TPU film has a melting point of 130° C. or higher. Preferably, the melting point of the TPU film may be 150° C. to 160° C., but not limited thereto.

According to the present invention, the TPU hot melt film can be in molten status during the heat pressing process, to adhere the color migration blocking laminate to the fabric. Preferably, the TPU hot melt film has a thickness of 0.05 mm to 0.40 mm, but not limited thereto. Specifically, the TPU hot melt film can be obtained through T-die extrusion equipment with TPU pellets. Preferably, the melting point of the TPU hot melt film can be from 110° C. to 120° C., but not limited thereto.

According to the present invention, the polyurethane adhesive layer makes the laminate as a whole have better stability. Preferably, the polyurethane adhesive layer has a thickness of 0.01 mm to 0.02 mm, but not limited thereto. Specifically, the polyurethane adhesive layer can be obtained by knife coating either with a water-based or a solvent-based polyurethane solution on the first polyurethane film, but not limited thereto.

According to the present invention, the color migration blocking laminate adheres to the fabric to form a composite fabric. For example, the composite fabric can be a synthetic leather which can be applied to shoe materials, clothes, or cloth labels, but not limited thereto.

The fabric used in the composite fabric of the present invention is not specially limited. The material of fabric can be selected from natural fibers (e,g, cotton, linen, and wool), synthetic fibers (e.g., nylon, polyester, or polypropylene), blended fibers comprising at least one natural fiber and at least one synthetic fiber, and the like.

With feature of a laminate comprising a color migration blocking film made of the color migration blocking composition of the present invention, it is advantageous to block the migration of the dye colorant in the fabric to the top layer of the synthetic leather (e.g., the first polyurethane film) during the heat pressing process, thereby maintaining the original color of the top layer of the synthetic leather.

### BRIEF DESCRIPTION OF THE DRAWINGS

FIG. 1 is a schematic diagram of the side sectional view of the color migration blocking laminate 1-A of the present invention.

FIG. 2 is a schematic diagram of the side sectional view of the color migration blocking laminate 1-B of the present invention.

### DETAILED DESCRIPTION OF THE PREFERRED EMBODIMENTS

Examples and Comparative Examples are given below to illustrate the details of the present invention, and one person skilled in the art can easily realize the advantages and effects of the present invention from the description, and make various modifications and variations in order to practice or apply the present invention without departing from the spirit of the present invention. Raw materials:

(1) Phenoxy resin: purchased from Mitsubishi Chemical, Japan; product number: jER 1256; Mw: 51,000;
(2) Dimer acid-modified epoxy resin: purchased from CVC Thermoset Specialties, Inc.; product number: HyPox DA323; the amount of elastomer: 40 wt %; EEW: 660 g/eq;

(3) TPU-modified epoxy resin: purchased from CVC Thermoset Specialties. Inc.; product number: HyPox UA10; the amount of elastomer: 12 wt %; EEW: 215 g/eq;

(4) Butadiene-acrylonitrile liquid rubber-modified epoxy resin: purchased from CVC Thermoset Specialties, Inc.; product number: HyPox RA 1340; the amount of elastomer: 40 wt %; EEW: 350 g/eq;

(5) Curing agent: aliphatic polyisocyanate, purchased from Covestro AG; product number: Desmodur N-70;

(6) MEK: purchased from Nanpao Resins Chemical Group;
(7) PMA: purchased from LyondellBasell Industries N.V.;
(8) Aromatic 100: purchased from CPC Corporation, Taiwan.

Color Migration Blocking Composition

### Examples 1 to 4

The color migration blocking compositions of Examples 1 to 4 were respectively prepared according to the ratios (in wt %) shown in Table 1. First, PMA, MEK and Aromatic 100 were homogeneously mixed in a container according to the ratios shown in Table 1. After that, the phenoxy resin was added into a container at the ratio shown in Table 1, and continuously stirred until the phenoxy resin completely dissolved; then the elastomer-modified epoxy resin (i.e., dimer acid-modified epoxy resin, TPU-modified epoxy resin, or butadiene-acrylonitrile liquid rubber-modified epoxy resin) was added into the container at the ratio shown in Table 1 to obtain a mixed solution, and the mixed solution was stirred until clear and transparent. Then the curing agent was added at the ratio shown in Table 1 to obtain the color migration blocking composition. The color migration blocking composition had a viscosity of about 5000 centipoises (cps). The main differences of Examples 1 to 4 were the components comprised in the compositions and the amounts thereof.

Color Migration Blocking Film

The color migration blocking compositions of Examples 1 to 4 were respectively coated on a releasing film, and dried at 90° C., to obtain the color migration blocking films 1-1 to 4-1. All the color migration blocking films 1-1 to 4-1 had an average thickness of about 0.03 mm.

TABLE 1
Ratios of the components in the color migration
blocking compositions of Examples 1 to 4 and
the color migration blocking films thereof

| | Composition number | | | |
|---|---|---|---|---|
| | Example 1/ | Example 2/ | Example 3/ | Example 4/ |
| | Color | Color | Color | Color |
| | migration | migration | migration | migration |
| | blocking | blocking | blocking | blocking |
| | film | film | film | film |
| Film number | 1-1 (wt %) | 2-1 (wt %) | 3-1 (wt %) | 4-1 (wt %) |
| Phenoxy resin | 39.1 | 33.6 | 33.6 | 33.6 |
| Dimer acid- | 8.7 | 13.3 | 0 | 0 |
| modified | | | | |
| epoxy resin | | | | |
| TPU- | 0 | 0 | 13.3 | 0 |
| modified | | | | |
| epoxy resin | | | | |
| Butadiene- | 0 | 0 | 0 | 13.3 |
| acrylonitrile | | | | |
| liquid rubber- | | | | |
| modified | | | | |
| epoxy resin | | | | |
| Curing agent | 4.3 | 4.4 | 4.4 | 4.4 |
| MEK | 28.7 | 29.2 | 29.2 | 29.2 |
| PMA | 7.0 | 7.1 | 7.1 | 7.1 |
| Aromatic 100 | 12.2 | 12.4 | 12.4 | 12.4 |

Color Migration Blocking Laminates

Color Migration Blocking Laminate 1-A (L1-A)

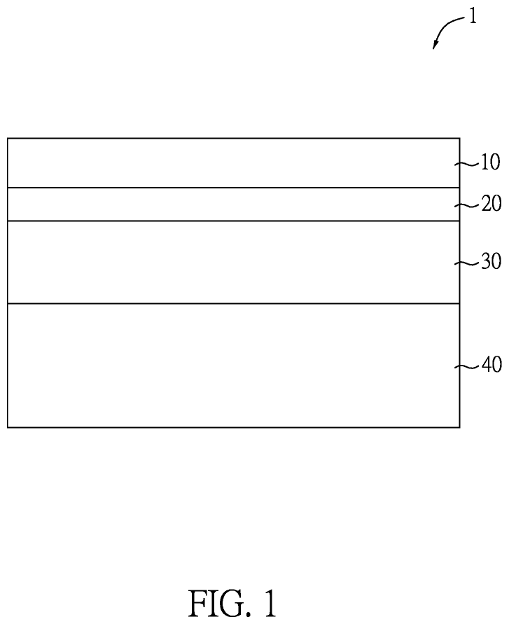

As shown in FIG. 1, first, the color migration blocking film 20 was directly laminated to one side of the first polyurethane film 10. After that, the TPU film 30 was directly adhered to the other side of the color migration blocking film 20. At last, the TPU hot melt film 40 was adhered to the other side of the TPU film 30, to obtain the color migration blocking laminate 1-A (i.e., the color migration blocking laminate 1 shown in FIG. 1).

The information of each layer comprised in the color migration blocking laminate 1-A was as below:

(1) First polyurethane film 10: purchased from Hsin-Li Chemical Industrial Corp.; thickness: 0.05 mm; color: white;

(2) Color migration blocking film 20: the color migration blocking film 1-1 formed by the color migration blocking composition of Example 1; thickness: 0.03 mm;

(3) TPU film 30: purchased from Jah Yih Enterprise Co., Ltd.; product number: HS; thickness: 0.10 mm;

(4) TPU hot melt film 40: purchased from Jah Yih Enterprise Co., Ltd.; product number: HM; thickness: 0.20 mm.

Color Migration Blocking Laminate 2-A (L2-A)

The color migration blocking laminate 2-A was prepared by the steps the same as those in the preparation of the color migration blocking laminate 1-A, except the color migration blocking film 1-1 in the color migration blocking laminate 1-A was changed to the color migration blocking film 2-1 formed by the color migration blocking composition of Example 2.

Reference Laminate 1-A (RL1-A)

The reference laminate 1-A was prepared by the steps the same as those in the preparation of the color migration blocking laminate 1-A, except the color migration blocking film 1-1 in the color migration blocking laminate 1-A was skipped, and the TPU film was directly adhered to one side of the first polyurethane film.

Color Migration Blocking Laminate 1-B (L1-B)

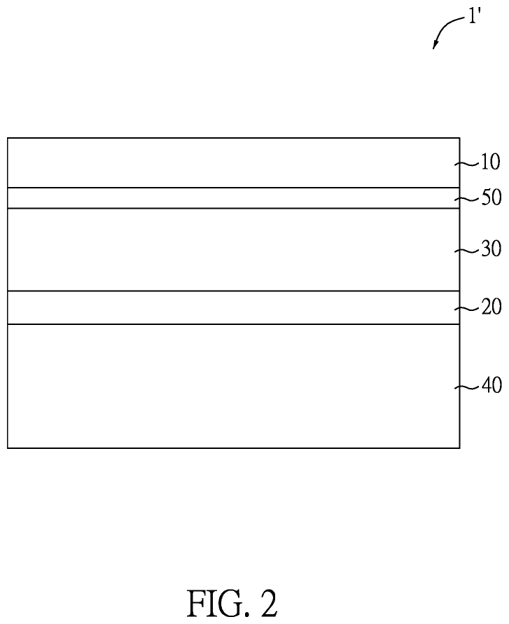

As shown in FIG. 2, first, a polyurethane adhesive solution was coated by knife coating and dried to form a polyurethane adhesive layer 50 on one side of the first polyurethane film 10. After that, the TPU film 30 was directly laminated to the other side of the polyurethane adhesive layer 50. Then the color migration blocking film 20 was adhered to the other side of the TPU film 30. At last, the TPU hot melt film 40 was adhered to the other side of the color migration blocking film 20, to obtain the color migration blocking laminate 1-B (i.e., the color migration blocking laminate 1′ shown in FIG. 2).

The information of each layer comprised in the color migration blocking laminate 1-B was as below:

(1) First polyurethane film 10: purchased from Hsin-Li Chemical Industrial Corp.; thickness: 0.04 mm; color: white;

(2) Polyurethane adhesive layer 50: purchased from Hsin-Li Chemical Industrial Corp.; thickness: 0.01 mm;

(3) TPU film 30: purchased from Jah Yih Enterprise Co., Ltd.; product number: HS; thickness: 0.10 mm;

(4) Color migration blocking film 20: the color migration blocking film 1-1 formed by the color migration blocking composition of Example 1; thickness: 0.03 mm;

(5) TPU hot melt film 40: purchased from Jah Yih Enterprise Co., Ltd.; product number: HM; thickness: 0.20 mm.

Color Migration Blocking Laminate 2-B (L2-B)

The color migration blocking laminate 2-B was prepared by the steps the same as those in the preparation of the color migration blocking laminate 1-B, except the color migration blocking film 1-1 in the color migration blocking laminate 1-B was changed to the color migration blocking film 2-1 formed by the color migration blocking composition of Example 2.

Color Migration Blocking Laminate 3-B (L3-B)

The color migration blocking laminate 3-B was prepared by the steps the same as those in the preparation of the color migration blocking laminate 1-B, except the color migration blocking film 1-1 in the color migration blocking laminate 1-B was changed to the color migration blocking film 3-1 formed by the color migration blocking composition of Example 3.

Color Migration Blocking Laminate 4-B (L4-B)

The color migration blocking laminate 4-B was prepared by the steps the same as those in the preparation of the color migration blocking laminate 1-B, except the color migration blocking film 1-1 in the color migration blocking laminate 1-B was changed to the color migration blocking film 4-1 formed by the color migration blocking composition of Example 4.

Reference Laminate 1-B (RL1-B)

The reference laminate 1-B was prepared by the steps the same as those in the preparation of the color migration blocking laminate 1-B, except the color migration blocking film 1-1 in the color migration blocking laminate 1-B was omitted, and the TPU hot melt film was directly adhered to one side of the TPU film.

Characteristic Analysis of Color Migration Blocking Laminates

L1-A, L2-A, RL1-A, and L1-B, L2-B, L3-B, L4-B, RL1-B were sequentially analyzed by the following experimental tests. Based on the conduct of meaningful experiments in the characteristic analysis, all the laminates were analyzed by the same experimental method. From above, it was clear that the main characteristic differences between each color migration blocking laminate and reference laminate (i.e., the main differences between L1-A, L2-A and RL1-A; and, the main differences between L1-B, L2-B, L3-B, L4-B and RL1-B) came from the differences that the laminates comprised the color migration blocking film or not.

Experimental Test 1: Vamp Flex Test L1-A, L2-A, RL1-A, and L1-B, L2-B, L3-B, L4-B, and RL1-B were respectively tested at 25° C. by the standard vamp flex test using SATRA TM25, and the results were listed in Table 2.

TABLE 2
Results of Vamp Flex Test from L1-A, L2-A,
RL1-A, L1-B, L2-B, L3-B, L4-B, and RL1-B

| Sample number | Number of flexing cycles (cycle) |
|---|---|
| L1-A | >100,000 |
| L2-A | >100,000 |
| RL1-A | >100,000 |
| L1-B | >110,000 |
| L2-B | >110,000 |
| L3-B | >110,000 |
| L4-B | >110,000 |
| RL1-B | >110,000 |

Experimental Test 2: Color Migration Blocking Ability Test

Each of the following laminates was respectively adhered to the same red polyester fabric by heat pressing to form a variety of synthetic leathers. The synthetic leathers were assessed by both the Nike Test G59 rubber accelerated ageing test under Condition A, and the Adidas GE-08 hydrolysis test under Condition B, and then assessed by EN ISO 105-A3 grayscale test for assessing the staining level of the white first polyurethane film of each synthetic leather under different conditions.

The results of the grayscale test could be assessed in nine grades: 5, 4.5, 4, 3.5, 3, 2.5, 2, 1.5, and 1. Grade 5 indicated that the observer did not see any staining on the first polyurethane film by naked eyes; on the contrary, grade 1 indicated that the observer saw high-level staining on the first polyurethane film by naked eyes.

Condition A: Air-Circulating Oven

First, the synthetic leathers obtained from all laminates and reference laminates were fixed in an air-circulating oven, the temperature of the oven was maintained at 70° C., and each of the synthetic leathers should not be contacted with each other. After that, the fabrics were taken out every 24 hours for 7 days. The staining level of the first polyurethane film of each synthetic leather was observed by the grayscale test, and the assessment results of the synthetic leathers comprising L1-A, RL1-A were recorded in Table 3, and the assessment results of the synthetic leathers comprising L1-B, L2-B, L3-B, L4-B, and RL1-B were recorded in Table 4-1.

Condition B: Humidity Chamber

First, the synthetic leathers obtained from all laminates and reference laminates were fixed in a humidity chamber, in which the temperature of the humidity chamber was maintained at 70° C., and the humidity of the humidity chamber was maintained at 95% RH. After that, the synthetic leathers were taken out every 24 hours for 7 days. The staining level of the first polyurethane film of each synthetic leather was observed by the grayscale test, the assessment results of the synthetic leathers comprising L1-A and RL1-A were recorded in Table 3, and the assessment results of the synthetic leathers comprising L1-B, L2-B, L3-B, L4-B, and RL1-B were recorded in Table 4-2.

TABLE 3
Results of color migration blocking ability of L1-A and RL1-A

| | L1-A | | RL1-A | |
|---|---|---|---|---|
| | Grayscale | Grayscale | Grayscale | Grayscale |
| | value under | value under | value under | value under |
| Day | Condition A | Condition B | Condition A | Condition B |
| Day 1 | 5 | 5 | 3.5 | 3 |
| Day 2 | 5 | 4.5 | 3.5 | 2.5 |
| Day 3 | 5 | 4.5 | 3 | 2.5 |
| Day 4 | 4.5 | 4.5 | 3 | 2 |
| Day 5 | 4.5 | 4 | 2.5 | 2 |
| Day 6 | 4.5 | 4 | 2.5 | 1.5 |
| Day 7 | 4.5 | 4 | 2.5 | 1.5 |

TABLE 4-1
Results of color migration blocking ability of L1-B,
L2-B, L3-B, L4-B and RL1-B under Condition A

| | Grayscale value | | | | |
|---|---|---|---|---|---|
| Condition A | L1-B | L2-B | L3-B | L4-B | RL1-B |
| Day 1 | 5 | 5 | 5 | 4.5 | 3.5 |
| Day 2 | 5 | 5 | 5 | 4.5 | 3.5 |
| Day 3 | 5 | 5 | 4.5 | 4 | 3 |
| Day 4 | 5 | 5 | 4.5 | 4 | 2.5 |
| Day 5 | 5 | 5 | 4.5 | 4 | 2.5 |
| Day 6 | 4.5 | 5 | 4 | 3.5 | 2 |
| Day 7 | 4.5 | 4.5 | 4 | 3.5 | 2 |

TABLE 4-2
Results of color migration blocking ability of L1-B,
L2-B, L3-B, L4-B and RL1-B under Condition B

| | Grayscale value | | | | |
|---|---|---|---|---|---|
| Condition B | L1-B | L2-B | L3-B | L4-B | RL1-B |
| Day 1 | 5 | 5 | 5 | 4.5 | 3.5 |
| Day 2 | 5 | 5 | 5 | 4.5 | 3 |
| Day 3 | 5 | 5 | 4.5 | 4 | 2.5 |
| Day 4 | 4.5 | 5 | 4.5 | 4 | 2 |
| Day 5 | 4.5 | 4.5 | 4.5 | 3.5 | 1.5 |
| Day 6 | 4.5 | 4.5 | 4 | 3.5 | 1.5 |
| Day 7 | 4.5 | 4.5 | 4 | 3.5 | 1.5 |

Discussion of Experimental Test Results

From the results of vamp flex test in Table 2, it was clear that no matter whether L1-A and L1-B comprised a color migration blocking film or not, their flex resistance was equivalent to that of RL1-A which did not comprise a color migration blocking film. Similarly, L1-B to L4-B also had a flex resistance equivalent to that of RL1-B which did not comprise a color migration blocking film. Therefore, these tests proved that the color migration blocking film of the present invention had good flex resistance. In addition, from the test results of L1-A and L1-B, it was clear that no matter whether the polyurethane adhesive layer was comprised in the color migration blocking laminate of the present invention or not, the layers of the laminate, even after the vamp flexing test for more than 100 thousand flexing cycles, were maintained integral and inseparable. The test result proved that the color migration blocking film introduced in the laminate provided very good adhesion strength.

From the results in Table 3, Table 4-1 and Table 4-2, it was clear that the color migration blocking film of the present invention had a good ability for blocking color migration. Thus, in a laminate simultaneously comprising the first polyurethane film (as the top layer of the synthetic leather) and the color migration blocking film of the present invention, after the synthetic leather was adhered to the fabric by heat pressing to form a synthetic leather, the migration of the dye colorant from the fabric at the bottom to the top layer of the synthetic leather could be prevented.

From the above test results, it is clear that the color migration blocking composition of the present invention comprising a phenoxy resin and an elastomer-modified epoxy resin is very compatible with either polyurethane film or TPU film, so the color migration blocking film formed by the composition has good adhesion strength with the first polyurethane film, the TPU film and the TPU hot melt film, and has an ability to successfully block the migration of the colorant from the fabric at the bottom to the first polyurethane film at the top, thereby promoting the application value of the color migration blocking film of the present invention, the color migration blocking laminate and the composite fabric comprising the film.

The above examples are used to illustrate the present invention, not intended to limit the claims of the present invention. The variations and modifications not departing from the essence of the present invention should be considered to fall within the scope of the present invention.

What is claimed is:

1. A color migration blocking composition, comprising: 15 parts to 45 parts by weight of a phenoxy resin; 5 parts to 40 parts by weight of an elastomer-modified epoxy resin; 1.5 parts to 7.0 parts by weight of a curing agent; and 30 parts to 65 parts by weight of a solvent, based on 100 parts by weight of the color migration blocking composition.

2. The color migration blocking composition as claimed in claim 1, wherein the phenoxy resin has a weight average molecular weight of 20,000 to 80,000.

3. The color migration blocking composition as claimed in claim 1, wherein the elastomer-modified epoxy resin comprises: a dimer acid-modified epoxy resin, a thermoplastic polyurethane-modified epoxy resin, a butadiene-acrylonitrile liquid rubber-modified epoxy resin or any combinations thereof.

4. The color migration blocking composition as claimed in claim 3, wherein the dimer acid-modified epoxy resin has an epoxide equivalent weight of 500 g/eq to 1500 g/eq.

5. The color migration blocking composition as claimed in claim 3, wherein the thermoplastic polyurethane-modified epoxy resin has an epoxide equivalent weight of 200 g/eq to 700 g/eq.

6. The color migration blocking composition as claimed in claim 3, wherein the butadiene-acrylonitrile liquid rubber-modified epoxy resin has an epoxide equivalent weight of 300 g/eq to 1400 g/eq.

7. The color migration blocking composition as claimed in claim 1, wherein the curing agent comprises an isocyanate type curing agent, an amine type curing agent, or a combination thereof.

8. The color migration blocking composition as claimed in claim 1, wherein the solvent comprises a first solvent and a second solvent; the first solvent is a polar aprotic solvent, and the second solvent is a hydrocarbon solvent.

9. A color migration blocking film, which is formed by the color migration blocking composition as claimed in claim 1.

10. A color migration blocking laminate, comprising: a first polyurethane film, the color migration blocking film as claimed in claim 9, a thermoplastic polyurethane film, and a thermoplastic polyurethane hot melt film; wherein the color migration blocking film and the thermoplastic polyurethane film are inserted between the first polyurethane film and the thermoplastic polyurethane hot melt film.

11. The color migration blocking laminate as claimed in claim 10, wherein the color migration blocking laminate comprises sequentially from top to bottom: the first polyurethane film, the color migration blocking film, the thermoplastic polyurethane film, and the thermoplastic polyurethane hot melt film.

12. The color migration blocking laminate as claimed in claim 10, wherein the color migration blocking laminate further comprises a polyurethane adhesive layer, the polyurethane adhesive layer is inserted between the first polyurethane film and the color migration blocking film, or the polyurethane adhesive layer is inserted between the first polyurethane film and the thermoplastic polyurethane film.

13. The color migration blocking laminate as claimed in claim 12, wherein the color migration blocking laminate comprises sequentially from top to bottom: the first polyurethane film, the polyurethane adhesive layer, the thermoplastic polyurethane film, the color migration blocking film, and the thermoplastic polyurethane hot melt film.

14. A composite fabric, comprising the color migration blocking laminate as claimed in claim 10 and a fabric; and the fabric is adhered to the thermoplastic polyurethane hot melt film comprised in the color migration blocking laminate.

15. A use of the composite fabric as claimed in claim 14, wherein the composite fabric is applied to shoe materials, clothes or cloth labels.
